(19) United States
(12) Patent Application Publication
(10) Pub. No.: US 2002/0066177 A1
(43) Pub. Date: Jun. 6, 2002

(54) Method for manufacturing magneto-resistive effect type magnetic heads

(75) Inventors: Akio Takada, Kanagawa (JP); Katsuki Sasaki, Kanagawa (JP); Toshihiko Shimizui, Kanagawa (JP); Kohki Matsuki, Miyagi (JP)

Correspondence Address: David R. Metzger, SONNENSCHEIN NATH & ROSENTHAL, P.O. Box #061080, Wacker Drive Station, Sears Tower, Chicago, IL, 60606-1080, US

(73) Assignee: SONY CORPORATION

(21) Appl. No.: 09/899,399

(22) Filed: Jul. 5, 2001

(30) Foreign Application Priority Data
Jul. 11, 2000 (JP) P2000-210327

(51) Int. Cl. G11B 5/127

(52) U.S. Cl. 29/603.07; 29/603.09

(57) ABSTRACT

Providing a method for manufacturing magneto-resistive effect type magnetic heads which can suppress the electrostatic destructions due to the ESD and EOS, and can properly manufacture magneto-resistive effect type magnetic heads without deteriorating characteristics. In a layered type magnetic head forming step S1, a short circuit pattern for making a short circuit in the element circuit of an MR head is formed. And the short circuit pattern is cut off before a fine polishing step S4, or at a wafer bar cutting off step S6.

### BACKGROUND OF THE INVENTION

1. Field of the Invention

The present invention relates to a method for manufacturing magneto-resistive effect type magnetic heads for use as reproducing heads in, for example, hard disc drives.

2. Description of Related Art

Recently, in a magnetic recording/reproducing apparatus such as a hard disc drive, a magneto-resistive effect type magnetic head (referred to as an MR head, hereinafter) is widely used as a reproducing head for reading out signals recorded on a magnetic recording medium.

The MR head is a magnetic head which reads out signals recorded on a magnetic recording medium by utilizing magneto-resistive effect of a magneto-resistive effect element (referred to as an MR element, hereinafter). The MR head generally has a pair of upper and lower magnetic shield layers of soft magnetic films, a gap made of a non-magnetic non-conductive film provided between the upper and lower magnetic shield layers, and an MR element in the form of a thin-film embedded into the gap. In the MR head, the MR element has a portion thereof exposed to outside, and resistance value of the MR element changes in accordance with changes of external magnetic fields. Also, the MR element is electrically connected to a pair of terminals, and the change of the resistance value of the MR element according to the changes of the external magnetic fields can be detected as voltage change from the terminals.

The MR head is high in reproduction sensitivity as compared with an inductive type magnetic head which reads out signals recorded on a magnetic recording medium by utilizing magnetic induction, and can surely detect even slight changes of external magnetic fields. So, the MR head is a suitable reproducing head for a magnetic recording/reproducing apparatus oriented to the high recording density. Especially, in recent years, a giant magneto-resistive effect element (referred to as a GMR element, hereinafter) of a spin valve structure which can realize giant magneto-resistive effect larger than the conventional anisotropic magneto-resistive effect is coming into use as the MR element, and the reproduction sensitivity has been improved significantly. So, the MR head is an essential device to the realization of the higher recording density.

So as to meet the high recording density, the width and height of above described MR head are desired to be reduced in size. That is, an MR head of a reduced width can realize the reduction of track widths and track pitches, while an MR head of a reduced height can realize the improvement of data outputting.

On the other hand, as the width and height of above described MR head are reduced in size, there are often caused electrostatic destructions due to electrostatic discharge (ESD) and electrical over stress (EOS) in processes of manufacturing MR heads.

As described above, the MR head generally has a pair of upper and lower magnetic shield layers with a gap provided therebetween, and an MR element embedded into the gap. The thickness of the gap, or the gap length, between the magnetic shield layers is extremely thin, which size is several hundred mn. So, if there is caused a potential difference between both ends of the gap, there is a possibility of causing an element destruction in the MR element embedded into the gap.

Such a potential difference between both ends of the gap is caused easily when a worker touches the MR head by mistake or a charged material is accidentally brought into contact with the MR head. Furthermore, as described above, since the MR element has a portion thereof exposed to outside, the MR head is sensitive to changes of external magnetic fields. So, the MR head is of a structure, in which a potential difference is easily caused. For this reason, there arises a necessity of taking countermeasures against the electrostatic destructions especially in the processes of manufacturing MR heads, as well as in the processes of manufacturing semiconductor integrated circuits and liquid crystal panels.

So, various countermeasures considered to be effective against the electrostatic destructions are taken in the processes of manufacturing MR heads. For example, workers are obliged to wear antistatic shoes, antistatic working clothes, wrist straps, and to use device earths, ionizers, and conductive mats.

However, even though such countermeasures has been taken, there are sometimes found characteristics deteriorations due to the electrostatic destructions in the MR heads. So, all the electrostatic destructions are not completely prevented at present.

Furthermore, the characteristics of MR heads meeting the high recording density whose widths and heights are reduced in size are deteriorated even in a low charged potential of approximately 25 V, and some MR heads in which electrostatic destructions due to the ESD and EOS are considered to have taken place are found. In case the high recording density will be promoted in the future, it is considered that such electrostatic destructions will take place more and more. So, it is desired that further countermeasures considered to be more effective against the electrostatic destructions will have to be taken.

### SUMMARY OF THE INVENTION

It is therefore an object of the present invention to overcome the above-mentioned drawbacks by providing a method for manufacturing magneto-resistive effect type magnetic heads which can suppress the electrostatic destructions due to the ESD and EOS, and can properly manufacture magneto-resistive effect type magnetic heads without deteriorating characteristics.

According to the present invention, there is provided a method for manufacturing magneto-resistive effect type magnetic heads, in which a plurality of element circuits each having a magneto-resistive effect element and a pair of terminals connected to the magneto-resistive effect element are formed on a wafer, and the wafer having the element circuits formed thereon is cut off for each element circuit so as to manufacture a plurality of magneto-resistive effect type magnetic heads at a time, the method including the steps of:

forming a short circuit pattern for making a short circuit in each of the element circuits at the stage of forming the element circuits on the wafer; and

cutting off the short circuit pattern in each of the element circuits before the stage of completing the magneto-resistive effect type magnetic head.

According to the method for manufacturing magneto-resistive effect type magnetic heads of the present invention, since a short circuit pattern for making a short circuit is formed in each of the element circuits at the stage of forming the element circuits on the wafer, the electrostatic destruction in the magneto-resistive effect element due to the ESD and EOS can be effectively prevented. And, since the short circuit pattern in each of the element circuits is cut off before the stage of completing the magneto-resistive effect type magnetic head, the completed magneto-resistive effect type magnetic head can properly detect the change of the resistance value of the magneto-resistive effect element according to the changes of the external magnetic fields.

It is desired that the short circuit pattern should be cut off before the stage of determining the height of the magneto-resistive effect element, or at the stage of cutting off the wafer having the element circuits formed thereon for each element circuit.

In case the short circuit pattern is cut off before the stage of determining the height of the magneto-resistive effect element, the electrostatic destruction in the magneto-resistive effect element due to the ESD and EOS can be effectively prevented by the short circuit pattern before the stage of determining the height of the magneto-resistive effect element. In this case, the resistance value of the magneto-resistive effect element can be detected at the time of determining the height of the magneto-resistive effect element. So, the ultimate height of the magneto-resistive effect element of a preferred performance can be determined by investigating the characteristics of the manufactured magneto-resistive effect type magnetic head beforehand based on the detected resistance value.

In case the short circuit pattern is cut off at the stage of cutting off the wafer having the element circuits formed thereon for each element circuit, the height of the magneto-resistive effect element cannot be determined while the resistance value of the magneto-resistive effect element is measured. Instead, the electrostatic destruction in the magneto-resistive effect element due to the ESD and EOS can be effectively prevented until the stage of cutting off the wafer having the element circuits formed thereon for each element circuit. In this case, the characteristics examination of the magneto-resistive effect type magnetic head is performed after the wafer bar is cut off for each element circuit.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 shows a perspective view of a slider head viewed from the ABS side.

FIG. 2 shows an enlarged perspective view of a layered type magnetic head of the slider head.

FIG. 3 shows a flow chart for explaining the method for manufacturing the slider heads employing the present invention.

FIG. 4 shows a perspective view of a wafer having a plurality of layered type magnetic heads and terminals formed thereon for explaining the method for manufacturing the slider heads employing the present invention.

FIG. 5 shows a plan view indicating the state in which a short circuit pattern for making a short circuit in an element circuit of an MR head is formed for explaining the method for manufacturing the slider heads employing the present invention.

FIG. 6 shows a perspective view of a wafer bar for explaining the method for manufacturing the slider heads employing the present invention.

FIG. 7A shows an enlarged plan view indicating a cutting off position of the wafer bar, and FIG. 7B shows an enlarged plan view indicating the state in which the short circuit pattern is cut off by forming a cut, both for explaining the method for manufacturing the slider heads employing the present invention.

FIG. 8 shows a perspective view of the wafer bar having resist patterns formed on a main surface thereof for explaining the method for manufacturing the slider heads employing the present invention.

FIG. 9 shows a perspective view of the wafer bar having convex patterns corresponding to floatation patterns formed on the main surface thereof for explaining the method for manufacturing the slider heads employing the present invention.

FIG. 10 shows the characteristics of the slider heads manufactured by a conventional manufacturing method.

FIG. 11 shows the characteristics of the slider heads manufactured by a manufacturing method according to the present invention.

FIG. 12 shows a plan view of a short circuit pattern of another shape.

FIG. 13 shows a plan view of a short circuit pattern of yet another shape.

### DESCRIPTION OF THE PREFERRED EMBODIMENTS

Preferred embodiments according to the present invention will further be described below with reference to the accompanying drawings. In the following description, the present invention is employed to a case of manufacturing slider heads for use in hard disc drives, each of which has a slider having a main surface as an air bearing surface and is provided with a layered type magnetic head on a side surface of the slider. The layered type magnetic head consists of a magneto-resistive effect type magnetic head (referred to as an MR head, hereinafter) for use as a reproducing bead and an inductive thin-film head for use as a recording head layered on the MR head. On the other hand, the present invention is not restricted to the following embodiment, and is widely employed to other cases of manufacturing slider heads.

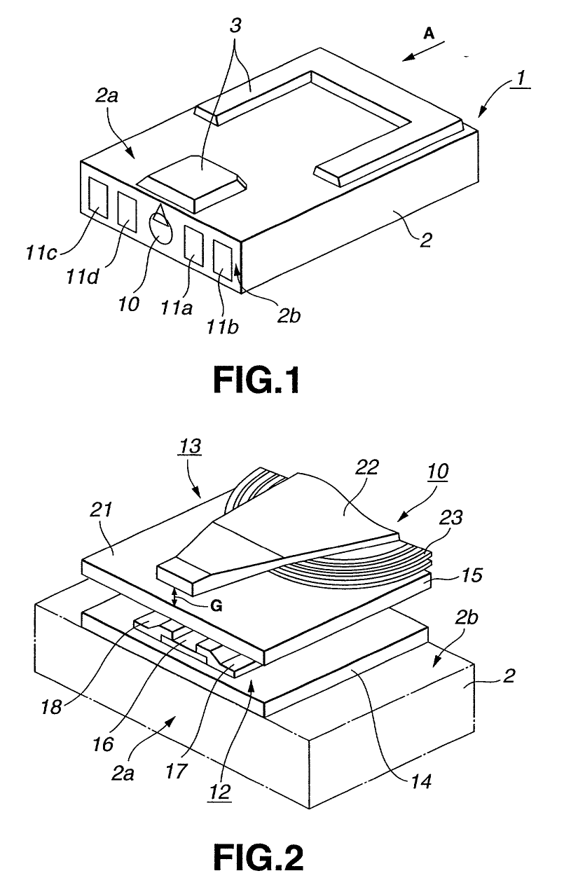

A slider head 1 for use in a hard disc drive has a slider 2 made of hard material such as AlTiC in the form of a rectangular plate. The slider 2 has a main surface 2a which is provided with floatation patterns 3 for floating the slider 2 itself by receiving an airflow generated due to the rotating operation of a magnetic disc used as a recording medium. The floatation patterns 3 are formed in predetermined shapes so that the slider 2 can obtain an appropriate floatation to float itself by receiving an airflow shown as an arrow A in FIG. 1. The main surface 2a provided with floatation patterns 3 works as an ABS (Air Bearing Surface).

The slider 2 has a side surface 2b as an air outflow side which is provided with a layered type magnetic head 10 for writing/reading out signals to/from a magnetic disc, and terminals 11a, 11b, 11c, and 11d for making electrical connections between the layered type magnetic head 10 and external circuits.

The layered type magnetic head 10 has an MR head 12 for use as a reproducing head for reading out signals by magneto-resistive effect and an inductive thin-film head 13 for use as a recording head for writing signals by magnetic induction, and the inductive thin-film head 13 is layered on the MR head 12.

The MR head 12 has a lower magnetic shield layer 14 and an upper magnetic shield layer 15 each of a soft magnetic film, and an MR element 16 for sensing magnetic fields which is held between the lower magnetic shield layer 14 and the upper magnetic shield layer 15 via a gap film made of a non-magnetic non-conductive material. The MR element 16 is a GMR film (MR element 16 which is of the GMR film will be referred to as GMR element 16, hereinafter) of a spin valve structure which can realize giant magneto-resistive effect. The GMR element 16 is formed such that one end thereof faces a signal recording surface of a magnetic disc from the main surface 2a as the ABS of the slider 2. The GMR element 16 has its both left and right sides connected to one ends of a pair of reproducing electrodes 17 and 18, respectively. The other ends of the reproducing electrodes 17 and 18 are connected to the terminals 11a and 11b via conductive patterns, respectively.

In the slider head 1, the GMR element 16, reproducing electrodes 17, 18 of the MR head 12, a pair of the conductive patterns, and the terminals 11a and 11b form an element circuit for reading out signals recorded on a signal recording surface of a magnetic disc. In the MR head 12, the resistance value of the GMR element 16 changes in accordance with magnetic fields of a magnetic disc which changes corresponding to signals recorded on a signal recording surface of a magnetic disc. And the change of the resistance value of the GMR element 16 is detected as a voltage change via the terminals 11a and 11b.

In the layered type magnetic head 10, the upper magnetic shield layer 15 of the MR head 12 works also as a lower layer core 21 of the inductive thin-film head 13. The inductive thin-film head 13 has the lower layer core 21 and an upper layer core 22 which jointly form a magnetic core, and face each other with a gap G at the side of the main surface 2a as the ABS of the slider 2. The inductive thin-film head 13 has a thin-film coil 23 wound and layered between the lower layer core 21 and the upper layer core 22 apart from the main surface 2a of the slider 2. The lower layer core 21 and upper layer core 22 are connected to each other at a position farthest from the main surface 2a of the slider 2.

The thin-film coil 23 is formed spirally, whose center is located at a connection point of the lower layer core 21 and the upper layer core 22. The thin-film coil 23 has the inner end and the outer end thereof connected to the terminals 11c and 11d via conductive patterns, respectively.

The inductive thin-film head 13 has the thin-film coil 23 driven in accordance with signals to be recorded to a signal recording surface of a magnetic disc, and generates leakage fluxes in accordance with signals to be recorded from the gap G between the lower layer core 21 and the upper layer core 22 jointly forming the magnetic core. The signals are recorded to a signal recording surface of a magnetic disc by applying the leakage fluxes thereto.

Thus configured layered type magnetic head 10 is formed on the side surface 2b as an air outflow side of the slider 2 under a thin-film forming process. And a protective film made of Al₂O₃ etc., not shown, is formed around the layered type magnetic head 10 of the slider head 1, and the layered type magnetic head 10 is protected by the protective film.

Thus configured slider head 1 is mounted to one end of a suspension arm of a hard disc drive such that the main surface 2a as the ABS of the slider 2 faces a signal recording surface of a magnetic disc. When the magnetic disc is rotated, there is caused an airflow between the magnetic disc and the slider head 1. The main surface 2a as the ABS of the slider 2 receives the airflow generated due to the rotating operation of the magnetic disc and floats the slider head 1 by a predetermined floating amount. At this time, the layered type magnetic head 10 is driven and signals are recorded/read out to/from the magnetic disc.

Next, a method for manufacturing the slider heads 1 employing the present invention will be described.

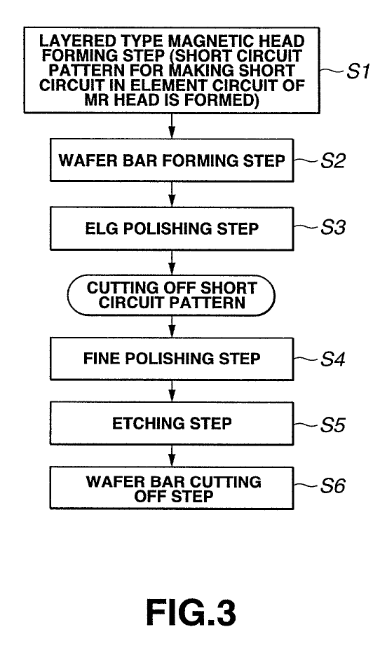

FIG. 3 shows manufacturing steps for manufacturing the slider heads 1. As shown, the slider heads 1 are manufactured through a layered type magnetic head forming step S1, a wafer bar forming step S2, an ELG polishing step S3, a fine polishing step S4, an etching step S5, and a wafer bar cutting off step S6.

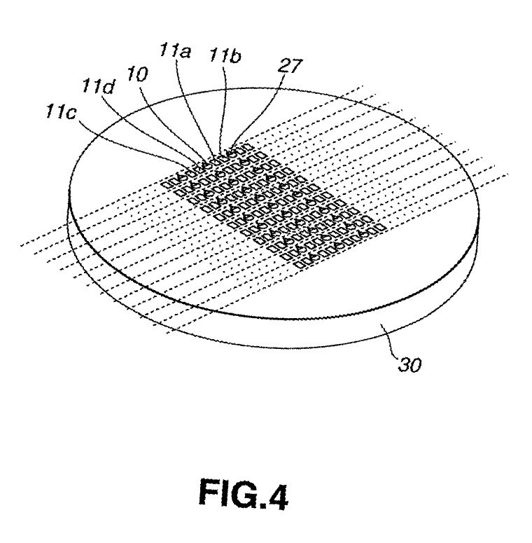

At first, in the layered type magnetic head forming step S1, a plurality of layered type magnetic heads 10 and a plurality of terminals 11a, 11b, 11c, 11d are formed on a wafer 30 made of AlTiC etc. at a time by a thin-film forming process, as shown in FIG. 4. At this time, there are also formed a plurality of resistance sensors 27 for use in the ELG polishing step S3 to be described later, each of which is for each set of the layered type magnetic head 10 and terminals 11a, 11b, 11c, 11d. The wafer 30 will consequently be the sliders 2 of the slider heads 1.

In the manufacturing method according to the present invention, in the layered type magnetic head forming step S1, a short circuit pattern 26 for making a short circuit in the element circuit of the MR head 12, that is the element circuit for reading out signals recorded on a signal recording surface of a magnetic disc is formed to electrically connect the GMR element 16, reproducing electrodes 17, 18 of the MR head 12, a pair of the conductive patterns 24 and 25, and the terminals 11a and 11b for each set of the layered type magnetic head 10 and terminals 11a, 11b, 11c, 11d.

The short circuit pattern 26 has one end 26a thereof connected to the terminal 11a and the other end 26b thereof connected to the terminal 11b. The short circuit pattern 26 has the middle portion thereof extended to the resistance sensor 27. The resistance sensor 27 will consequently be removed after the completion of the slider head 1. Thus, the middle portion of the short circuit pattern 26 extended to the resistance sensor 27 will also be removed consequently.

The short circuit pattern 26 has only the one end 26a and other end 26b thereof connected to the terminal 11a and terminal 11b, and has the other portion thereof surely insulated from the element circuit and resistance sensor 27.

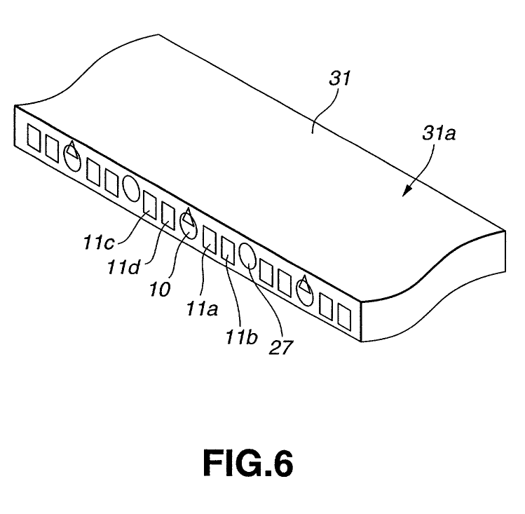

Next, in the wafer bar forming step S2, the wafer 30 on which the plural layered type magnetic heads 10 and terminals 11a, 11b, 11c, 11d are formed is cut off along dotted lines shown in FIG. 4. Thus, there are formed a plurality of wafer bars 31 shown in FIG. 6. At this time, since there is formed a short circuit in each of the element circuits of the MR heads 12 by the short circuit pattern 26, the electrostatic destruction is effectively prevented in the GMR elements 16 in the wafer bar forming step S2.

Next, in the ELG polishing step S3, the ELG (Electric Lapping Guide) polishing is performed for each of the wafer bars 31. In performing the ELG polishing, a main surface 31a of the wafer bar 31 is polished by controlling the polishing quantity based on output from the resistance sensors 27. Thus, the height of the GMR element 16 of the MR head 12, that is the height of the GMR element 16 apart from the side of the main surface 31a of the wafer bar 31, which will consequently be the ABS of the sliders 2, will be a predetermined value.

The resistance sensor 27 has a sensor portion 27a which is a film same as the GMR element 16 of the MR head 12 and is located at a height same as that of the GMR element 16. The sensor portion 27a is connected to a pair of electrodes 27b and 27c, and the change of the resistance value of the sensor portion 27a can be detected as a voltage change from the electrodes 27b and 27c.

The resistance values of the GMR element 16 of the MR head 12 and the sensor portion 27a of the resistance sensor 27 change in accordance with the heights of these elements. That is, the resistance values of the GMR element 16 and sensor portion 27a increase as the heights thereof decrease. Accordingly, the height of the GMR element 16, which substantially becomes equal to that of the sensor portion 27a, can be found by detecting the resistance value of the sensor portion 27a of the resistance sensor 27.

In the ELG polishing step S3, the wafer bar 31 has the main surface 31a polished by a predetermined quantity so that the GMR element 16 has a predetermined height while the height of the GMR element 16 is measured based on the resistance value of the sensor portion 27a of the resistance sensor 27. At this time, since there is formed a short circuit in each of the element circuits of the MR heads 12 by the short circuit pattern 26, the electrostatic destruction is effectively prevented in the GMR elements 16 in the ELG polishing step S3.

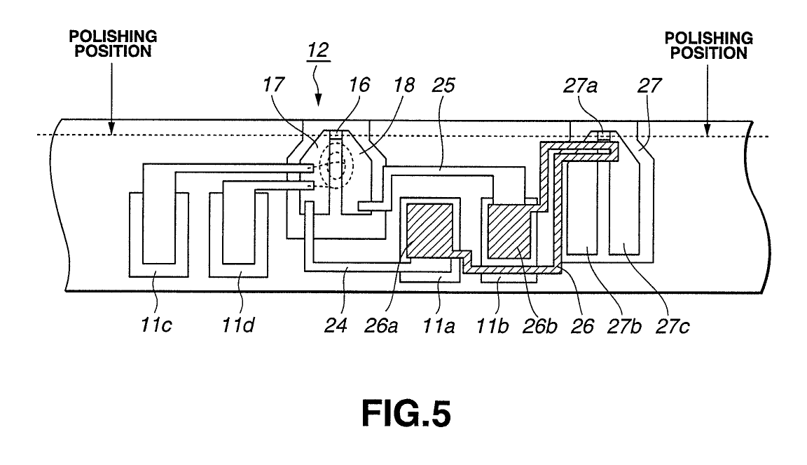

The ultimate height of the GMR element 16 is determined when the wafer bar 31 has the main surface 31a polished to be of a crown shape. Accordingly, in the ELG polishing step S3, the polishing quantity is controlled in view of the polishing to be performed in the fine polishing step S4. Specifically, the wafer bar 31 is polished so that the main surface 31 a reaches a polishing position shown as a dotted line in FIG. 5.

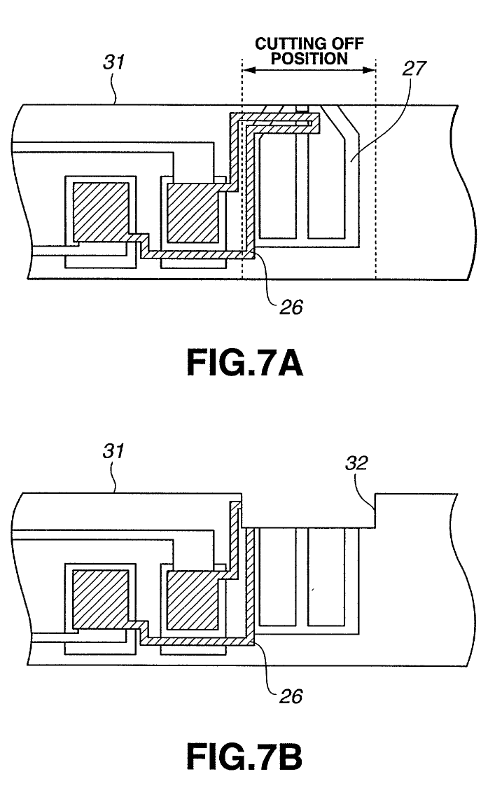

In the manufacturing method according to the present invention, before proceeding to the fine polishing step S4, the short circuit patterns 26 formed in the layered type magnetic head forming step S1 are cut off. As shown in FIG. 7A and 7B, the short circuit pattern 26 is cut off by applying a grinding stone to a cutting off position where the resistance sensor 27 of the wafer bar 31 is formed, shown as a dotted line, to form a cut 32 at the wafer bar 31 so that the middle portion of the short circuit pattern 26 is cut off and removed. This cut 32 works also as a positioning slot at the time of applying the grinding stone to the cutting off position in the wafer bar cutting off step S6, in which the wafer bar 31 is cut off.

Even though the electrostatic destruction is not prevented after the short circuit pattern 26 is cut off, since the electrostatic destruction in the GMR element 16 due to the ESD and EOS is surely prevented before the short circuit pattern 26 is cut off, the rate of occurrence of the electrostatic destruction in the GMR element 16 can significantly be reduced as a whole.

Since the element circuit of the MR head 12 becomes open after the short circuit pattern 26 is cut off, the height of the GMR element 16 can be determined with accuracy to improve the performance of the MR head 12 by correctly polishing the GMR element 16 while the resistance value of the GMR element 16 is measured in the fine polishing step S4.

After the completion of the cutting off of the short circuit patterns 26, fine polishing is performed for each wafer bar 31 in the fine polishing step S4. In the fine polishing step S4, the wafer bar 31 has the main surface 31 a polished to be of a crown shape which can realize a preferred floating attitude of the ultimately obtained slider 2, and the height of the GMR element 16 is adjusted to determine the ultimate height of the GMR element 16. At this time, the fine polishing is performed while the resistance value of the GMR element 16 is measured. As described above, since the resistance value of the GMR element 16 changes in accordance with the height thereof, the ultimate height of the GMR element 16 of a preferred performance can be determined by measuring the resistance value of the GMR element 16 to investigate the characteristics of the MR head 12 based on the measured resistance value and polishing the GMR element 16 based on the investigation.

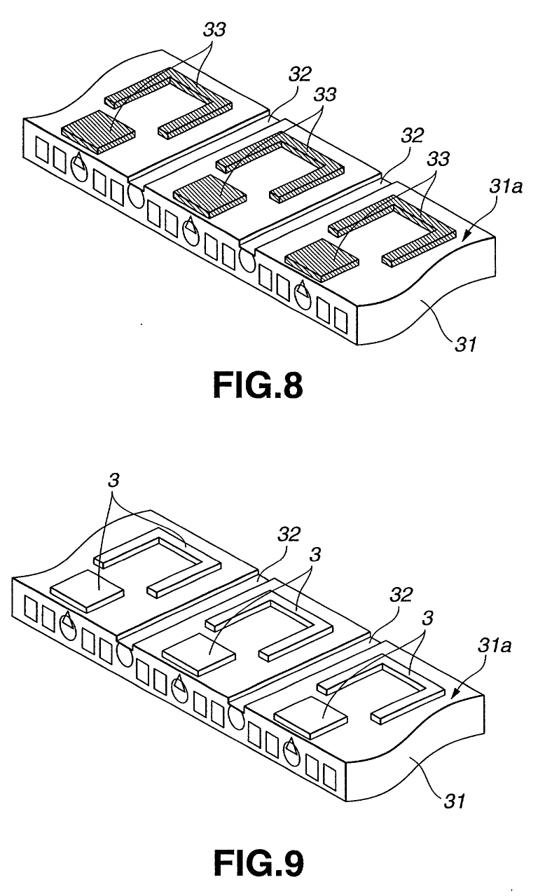

Next, in the etching step S5, there are formed resist patterns 33 which correspond to the floatation patterns 3 of the sliders 2 on the main surface 31a of the wafer bar 31 by a photolitho processing, as shown in FIG. 8. And, convex patterns as the floatation patterns 3 of the sliders 2 are finally formed on the main surface 31a of the wafer bar 31 by performing etching such as dry etching on the main surface 31a of the wafer bar 31 by the use of the resist patterns 33, as shown in FIG. 9.

Next, in the wafer bar cutting off step S6, the wafer bar 31 is cut off along the cuts 32 which are previously formed when the short circuit patterns 26 are cut off. Thus, the slider heads 1 shown in FIG. 1 are completed.

As in the above, according to the manufacturing method of the present invention, since the wafer bar forming step S2 and ELG polishing step S3 are performed in the state in which there has been formed a short circuit in each of the element circuit of the MR heads 12 by the short circuit pattern 26 formed in the layered type magnetic head forming step S1, the electrostatic destruction in the GMR element 16 due to the ESD and EOS is surely prevented and the rate of occurrence of the electrostatic destruction in the GMR element 16 in the ultimately obtained slider head 1 can significantly be reduced.

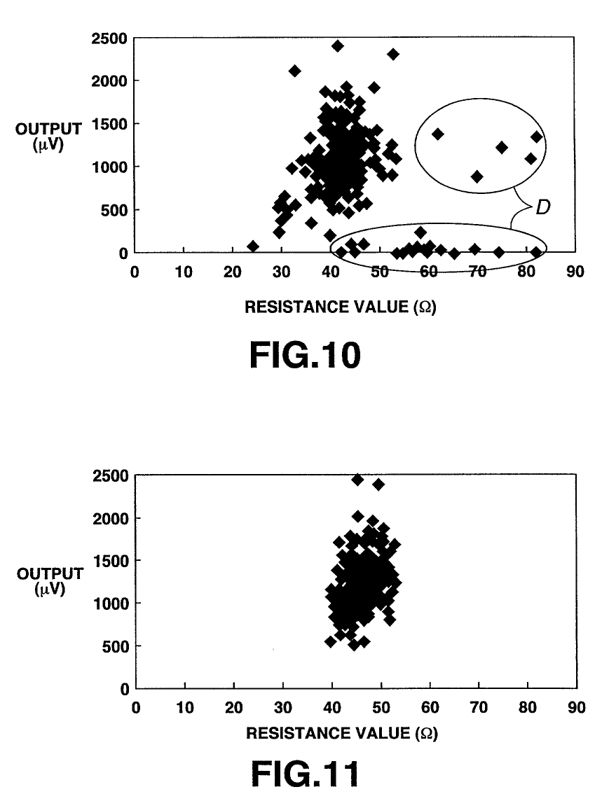

FIG. 10 shows the characteristics of the slider heads manufactured by a conventional manufacturing method in which the short circuit patterns 26 are not formed. FIG. 11 shows the characteristics of the slider heads 1 manufactured by a manufacturing method according to the present invention in which the short circuit patterns 26 are formed. The conventional manufacturing method is similar to that according to the present invention except that the short circuit patterns 26 are not formed. As shown in FIG. 10, there are found many slider heads which can not obtain any power output even though the resistance value is raised or whose characteristics are deteriorated (shown as D). This deterioration of the characteristics of the slider heads is considered to be caused due to the electrostatic destruction in the GMR element 16.

On the other hand, as shown in FIG. 11, there is found no slider head whose characteristics is deteriorated. It is considered that this is because there occurred no electrostatic destruction in the GMR element 16. As a result, the electrostatic destruction in the GMR element 16 can be effectively prevented when the slider heads 1 are formed by the manufacturing method according to the present invention.

In the aforementioned description, the short circuit patterns 26 are cut off before the ultimate height of the GMR element 16 is determined in the fine polishing step S4. On the other hand, the short circuit patterns 26 may be cut off in the wafer bar cutting off step S6 in which the wafer bar 31 is cut off.

In case the short circuit patterns 26 are cut off when the wafer bar 31 is cut off, since the short circuit in the element circuit of the MR head 12 by the short circuit pattern 26 remains until the wafer bar 31 is cut off, the ultimate height of the GMR element 16 can not be determined by correctly polishing the GMR element 16 while the resistance value of the GMR element 16 is measured in the fine polishing step S4.

Thus, in this case, the wafer bar 31 has the main surface 31a correctly polished by a predetermined quantity by controlling a polishing machine so that the GMR element 16 ultimately has a predetermined height. Then, the characteristics examination of the MR head 12 is performed after the wafer bar 31 is cut off in the wafer bar cutting off step S6 and the slider head 1 is completed. In correctly polishing the main surface 31 a of the wafer bar 31, since the cuts 32 are not formed on the wafer bar 31, and the resistance sensor 27 can be used, the correct polishing may be performed by controlling the polishing quantity in accordance with the output from the resistance sensor 27.

As described above, in case the short circuit patterns 26 are cut off when the wafer bar 31 is cut off, the GMR element 16 can not be correctly polished while the resistance value of the GMR element 16 is measured. In this case, the short circuit in the element circuit of the MR head 12 by the short circuit pattern 26 remains until the wafer bar 31 is cut off. So, the electrostatic destruction in the GMR element 16 due to the ESD and EOS is surely prevented until the wafer bar 31 is cut off. Thus, the electrostatic destruction in the GMR element 16 can be prevented more surely. In case the width and height of the GMR element 16 is reduced in size so as to meet the high recording density, it is considered that there will be often caused electrostatic destructions. So, in this case, cutting off the short circuit patterns 26 and wafer bar 31 concurrently is very effective.

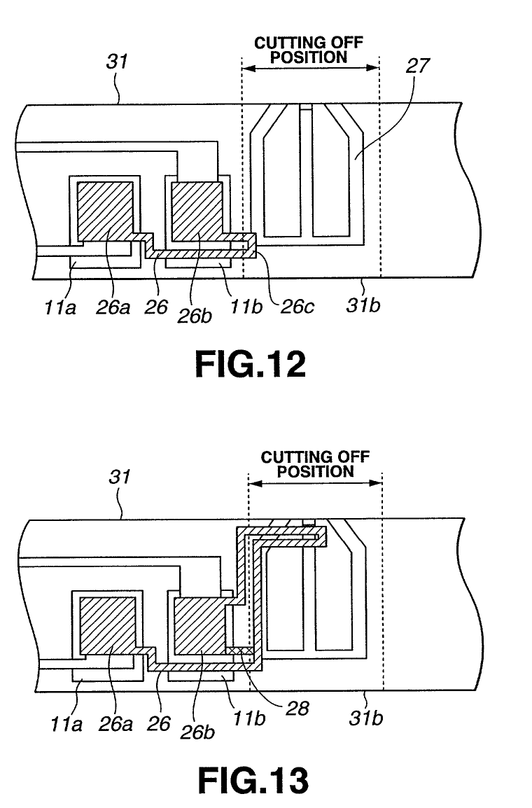

In case the short circuit patterns 26 are cut off when the wafer bar 31 is cut off, it is desired that the short circuit in the element circuit of the MR head 12 by the short circuit pattern 26 should remain as long as possible during the wafer bar 31 is being cut off so as to surely prevent the electrostatic destruction in the GMR element 16. In this case, as shown in FIG. 12, it is desired that the short circuit pattern 26 should have the middle portion 26c located on the other end 31b of the wafer bar 31 so that the applied grinding stone finally reaches the middle portion 26c.

In case the short circuit pattern 26 has the middle portion 26c located on the other end 31b of the wafer bar 31, the short circuit in the element circuit of the MR head 12 by the short circuit pattern 26 remains until the grinding stone reaches the middle portion 26c. Thus, the electrostatic destruction in the GMR element 16 can be prevented more surely. In this case, even though the grinding stone is applied to the cutting off position of the wafer bar 31 to make the cut 32, the short circuit pattern 26 is not cut off. Thus, the cuts 32 which work also as positioning slots at the time of applying the grinding stone to the cutting off position can be formed prior to the wafer bar cutting off step S6.

It may be desired that the shape of the short circuit pattern 26 should not be changed considerably in accordance with the cutting off stage of the short circuit pattern 26. In this case, it is desired that the shape of the short circuit pattern 26 shown in FIG. 5 should be rendered standard, and in case the short circuit patterns 26 are cut off when the wafer bar 31 is cut off, an additional patter 28 is added to the short circuit pattern 26 of the standard shape to form the short circuit pattern 26 having the additional patter 28, as shown in FIG. 13. In this case, the change of the shape of the short circuit pattern 26 in accordance with the cutting off stage can be minimized.

In the above described description, the shapes of the short circuit pattern 26 are preferred examples to form a short circuit in each of the element circuits, and the present invention is not restricted to those examples. That is, the shape of the short circuit pattern 26 can be appropriately changed in view of various conditions of such as manufacturing processes and costs. Furthermore, the short circuit pattern 26 can be so formed as to be embedded into the depth direction instead of being formed flatly.

According to the method for manufacturing magneto-resistive effect type magnetic heads of the present invention, since a short circuit pattern for making a short circuit is formed in each of the element circuits at the stage of forming the element circuits on the wafer, the electrostatic destruction in the magneto-resistive effect element due to the ESD and EOS can be effectively prevented until the short circuit pattern is cut off. And, since the short circuit pattern in each of the element circuits is cut off before the stage of completing the magneto-resistive effect type magnetic head, the magneto-resistive effect element is free from characteristics deterioration due to the electrostatic destruction, and the magneto-resistive effect type magnetic head capable of properly detecting the change of the resistance value of the magneto-resistive effect element according to the changes of the external magnetic fields can be manufactured.

What is claimed is:

1. A method for manufacturing magneto-resistive effect type magnetic heads, in which a plurality of element circuits each having a magneto-resistive effect element and a pair of terminals connected to the magneto-resistive effect element are formed on a wafer, and the wafer having the element circuits formed thereon is cut off for each element circuit so as to manufacture a plurality of magneto-resistive effect type magnetic heads at a time, the method comprising the steps of:
forming a short circuit pattern for making a short circuit in each of the element circuits at the stage of forming the element circuits on the wafer; and
cutting off the short circuit pattern in each of the element circuits before the stage of completing the magneto-resistive effect type magnetic head.

2. The method for manufacturing magneto-resistive effect type magnetic heads as set forth in claim 1, wherein the short circuit pattern is cut off before the stage of determining the height of the magneto-resistive effect element.

3. The method for manufacturing magneto-resistive effect type magnetic heads as set forth in claim 1, wherein the short circuit pattern is cut off at the stage of cutting off the wafer having the element circuits formed thereon for each element circuit.
